(19) United States
(12) Patent Application Publication
(10) Pub. No.: US 2002/0078021 A1
(43) Pub. Date: Jun. 20, 2002

(54) Method and system for organizing information into visually distinct groups based on user input

(76) Inventor: Scott S. Lawton, Chelmsford, MA (US)

Correspondence Address: FOLEY, HOAG & ELIOT, LLP, PATENT GROUP, ONE POST OFFICE SQUARE, BOSTON, MA, 02109, US

(21) Appl. No.: 09/972,740

(22) Filed: Oct. 5, 2001

Related U.S. Application Data
(60) Provisional application No. 60/238,587, filed on Oct. 6, 2000.
(60) Provisional application No. 60/238,577, filed on Oct. 6, 2000.
(60) Provisional application No. 60/238,791, filed on Oct. 6, 2000.
(60) Provisional application No. 60/238,754, filed on Oct. 6, 2000.
(60) Provisional application No. 60/237,254, filed on Oct. 2, 2000.
(60) Provisional application No. 60/237,250, filed on Oct. 2, 2000.
(60) Provisional application No. 60/237,243, filed on Oct. 2, 2000.
(60) Provisional application No. 60/237,252, filed on Oct. 2, 2000.
(60) Provisional application No. 60/237,249, filed on Oct. 2, 2000.

(51) Int. Cl. G06F 7/00

(52) U.S. Cl. 707/1

(57) ABSTRACT

A method and system whereby a user is presented with a visually clear and meaningful view of data objects, organized according to the user's preferred criteria; thereby helping the user understand the scope and content of the information. A computer with appropriate software formats the information based on user-supplied grouping criteria.

### REFERENCE TO RELATED APPLICATIONS

This application claims the benefit of and incorporates by reference the following applications:

U.S. Provisional Application Serial No. 60/238,587 filed Oct. 6, 2000; Method and System of Entering Search Criteria Using Multiple Entry Fields per Data Element, U.S. Ser. No. 60/238,577 filed Oct. 6, 2000; Method and System for Combining User-Supplied Sort Information with Secondary Sort Information, U.S. Ser. No. 60/238,791 filed Oct. 6, 2000; Enhanced Method and System for Viewing Any Search Result Without Returning to the Result List, U.S. Ser. No. 60/238,754 filed Oct. 6, 2000; Enhanced Method and System for Storing and Managing Search Criteria, U.S. Ser. No. 60/237,254 filed Oct. 2, 2001; Method and System for Modifying Search Criteria Based on Previous Search Date, U.S. Ser. No. 60/237,250 filed Oct. 2, 2001; Enhanced Method and System for Category Selection, U.S. Ser. No. 60/237,243 filed Oct. 2, 2001; Method and System for Pre-Filling Search Criteria into a Form, U.S. Ser. No. 60/237,249 filed Oct. 2, 2001, and Method and System for Organizing Search Results into a Single Page Showing Two Levels of Detail, U.S. Ser. No. 60/337,252 filed Oct. 2, 2001.

### FIELD OF THE INVENTION

The invention relates generally to organizing information retrieved from data repositories, and more particularly to a method and system for formatting information as visually distinct groups based on user input, whereby the visual grouping helps users understand the scope and content of the information.

### BACKGROUND OF THE INVENTION

As a society, we are increasingly becoming both dependent on and overloaded with information, especially data that is stored in computer databases or fill-text collections. As the quantity of information stored in these data repositories increases, the complexity of retrieving, organizing and understanding relevant information also increases. To locate relevant information, users search general collections (e.g., Alta Vista, Excite, InfoSeek, Lycos, Yahoo, etc.) as well as specialized sources which may be implemented with back-end databases, such as those dedicated to locating employment opportunities (e.g., CareerBuilder, CareerPath, Headhunter.net, HotJobs, Monster.com, etc.). These system typically organize retrieved information by sorting based on the value of one or more fields. According to recent studies from technology analysts (e.g., the Jupiter Group and Forrester Research), Internet searching is the most common online activity next to sending/receiving e-mail communications.

Data repositories may take on several forms, including relational databases, hierarchical databases, and flat-file databases, which generally support sorting by specific fields or columns, full-text collections which may or may not support sorting by fields or delimited portions of documents that are represented as fields, and/or one or more documents. As used herein, the term “data element” refers to a database field, a delimited portion of a document, meta information associated with a document, or to an entire document. As used herein, the term “data object” refers to a database record, a document, or some other grouping of associated data elements. As used herein, the term “data unit” refers to the value or contents of a data element. As used herein, the term “page” refers to a document or page on the World Wide Wide or other public or private network, e.g. a continuously scrollable body of information which may or may not include so-called “frames,” (i.e. portions that do not scroll automatically when other portions of the page are scrolled).

Most search engines on the Internet, whether general or specialized, return a list of search results as a set of one or a few lines for each matching data object, with the data objects sorted, in the case of full-text search engines, by the degree to which they matched the search criteria, and in the case of fielded search, by the value of a single field. Except for breaking a long list onto multiple pages, few search engines on the Internet visually arrange the results into distinct groups. Consequently, in order to understand the scope and content of the displayed information, a user may mentally try to organize the data into groups. Whether or not they consciously or unconsciously attempt to organize the data into groups, most users will spend more time reviewing the result information and getting less out of that review than if the data had been visually organized into groups for them.

Some search engines do organize result data into groups under certain circumstances, however, they do not provide the user with any meaningful control over how the information is grouped.

Methods and systems for arranging information into visually distinct groups are well known in the art, however, these methods and systems are limited to certain pre-defined groupings over which the user has little, if any, control. In fact, much information that is presented in visual groups is so arranged by hand.

Database “report writer” software, which is well known in the art, generally provides the capability to easily create a template or layout, which, when merged with the result of a search, will present the retrieved information in visually distinct groups. However, each template or layout specifies one or a small number of possible ways to group the data, and cannot adapt the grouping in any meaningful way based on user input. In addition, these report writers are generally used by more technical users who create reports, not by end users performing “ad hoc” searching.

In summary, the prior art does not provide a way for a user to have data grouped dynamically according to their specified criteria, forcing users to spend more time and energy understanding the scope and content of retrieved information.

### SUMMARY OF THE INVENTION

In the present invention, a computer with appropriate software organizes information into visually distinct groups based on user input. Groups are made distinct by techniques such as varying the location and/or text attributes of different data elements, and/or with the addition of lines, boxes or other graphic elements, and/or by removing redundant information that is common to every data object within a group.

The present invention overcomes the prior art limitations by giving a user control over the grouping criteria.

It is an object of the invention to reduce the time and frustration associated with finding and understanding information, by enabling information systems to provide visually clear and meaningful output that adapts to the user's preferred grouping criteria. It is a further object of the invention to enable computers to automate the process of organizing information in a useful manner while remaining flexible enough to adapt to user input.

Other objects and advantages of the invention will, in part, be obvious, and, in part, be shown from the following description.

### BRIEF DESCRIPTION OF THE DRAWINGS

FIG. 1 is a schematic representation depicting the components of one embodiment of the invention;

FIGS. 2a and 2b depict one set of illustrative input values and two illustrative output representations, and FIG. 2c depicts an illustrative modified input value and an illustrative output representation;

FIG. 3 is a flow chart depicting the steps for one illustrative method of one illustrative embodiment of the invention with grouped data objects;

FIG. 4 is a flow chart depicting the steps for one illustrative method of one illustrative embodiment of the invention with ungrouped data objects;

FIG. 5 is a schematic representation depicting one illustrative embodiment of the invention, wherein the invention is coupled to a network;

FIG. 6 is a schematic representation depicting one illustrative embodiment of the invention, wherein the invention interacts with a single electronic device.

### LIST OF REFERENCE NUMERALS

10 System components

12 controller

14 instruction port

16 secondary port

18 output port

20 filter

28 server computer

50 System with network

52A-52C IADs

54A-54C Web browsers

56 network

58 HTTP Web server

62 search engine

64 data repository

66 sort engine

68 server computer

90 System with single electronic device

### DESCRIPTION OF THE ILLUSTRATIVE EMBODIMENTS

To provide an overall understanding of the invention, certain illustrative embodiments will now be described. However, it will be understood by one of ordinary skill in the art that the methods and systems described herein may be adapted and modified for other suitable applications and that such other additions and modifications will not depart from the spirit and scope of the inventive concept.

To more clearly and concisely describe the subject matter of the invention, the following definitions are intended to provide guidance as to the meaning of specific terms used in the following written description, examples, and appended claims. As used herein, the term or phrase:

“communications network” and “network” include a LAN, a MAN, a WAN, an Intranet, an Extranet, the Internet, a wireless network (e.g., according to the WAP protocol), and the like;

“Information Location Mechanism” (hereinafter “ILM”) includes software, firmware and/or systems capable of searching a data repository to locate information that meets search criteria, such systems including database management systems, search engines supporting full-text search, search engines supporting fielded search, search engines supporting regular expressions and/or other patterns, and/or iterative search engines;

“Information Sorting Mechanism” (hereinafter “ISM”) includes software, firmware and/or systems capable of ordering data objects according to sort criteria, such systems including database management systems, text processing library routines, etc.;

“Internet Access Device” (hereinafter “IAD”) includes personal computer systems (hereinafter “PCs”), computer workstations, desktop computers, laptop computers, hand-held computers, television set-top boxes, wireless access devices such as mobile telephones, cellular telephones, pagers, beepers, and other various hand-held wireless devices, and all other devices that have at least one processor, UD and VDU, and are capable of accessing the Internet and/or other networks;

“processor” includes all components, devices, Integrated Circuits (hereinafter “ICs”), modules, software, subsystems, and/or systems that provide control and/or perform arithmetic and logical operations and/or extract computer instructions and/or decode computer instructions and/or execute computer instructions, such as a Central Processing Unit (hereinafter “CPU”), a microprocessor, a controller, and the like; including any associated memory or other electronic storage of data and/or instructions;

“User-input Device” (hereinafter “UD”) includes keyboards, keypads, mice, trackballs, trackpads, wheels, joysticks, graphics tablets, voice recognition devices, motion sensing devices and other devices for one or more users to enter text, numbers or other data and/or for pointing, clicking, tapping, selecting, dragging and/or other gestures or actions;

“Visual Display Unit” (hereinafter “VDU”) includes CRT screens, monitors, video display terminals, LCD screens, LED screens, digital paper, and all other devices that are capable of displaying analog or digital data;

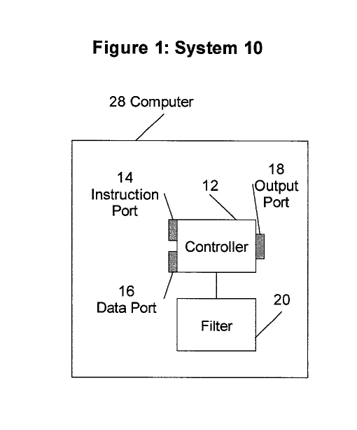

FIG. 1 depicts an illustrative embodiment of one system 10 according to the invention which organizes information into visually distinct groups based on user input. The system comprises a controller 12 containing an instruction port 14, a data port 16 and an output port 18, and a filter 20 coupled to the controller.

For this illustrative embodiment, the controller 12 with ports 14, 16 and 18, and the filter 20 reside on a single computer 28 which may be a Macintosh G3 running MacOS 8.5. For this illustrative embodiment, the controller 12 and filter 20 are coded in the UserTalk language embedded in UserLand Frontier, a commercial scripting and Web development system.

It will be readily apparent to those skilled in the art that the computer 28 could be a different Macintosh computer running a different version of MacOS or a different OS such as Linux, or an Intel or Intel-compatible PC or server running a version of the Microsoft Windows operating system such as Windows 98, Windows NT or Windows 2000, or an Intel or Intel-compatible PC or server running Linux or FreeBSD or other UNIX OS, or a computer from Sun, HP, IBM or other company, running Solaris, HP-UX, AIX or other variation of UNIX or other OS.

It will be readily apparent to those skilled in the art that the functions performed in this embodiment with a single computer 28 could be divided among a plurality of computers from the same or different manufacturers, with each computer running the same or different operating systems.

It will be readily apparent to those skilled in the art that controller 12 and/or filter 20 could be coded in any suitable scripting or programming language such as Perl, JavaScript, Java, VBScript, Visual BASIC, C++, etc. or any suitable Web development system such as Vignette StoryServer, Allaire ColdFusion, SilverStream, etc., and that controller 12 and filter 20 need not be coded in the same language or system.

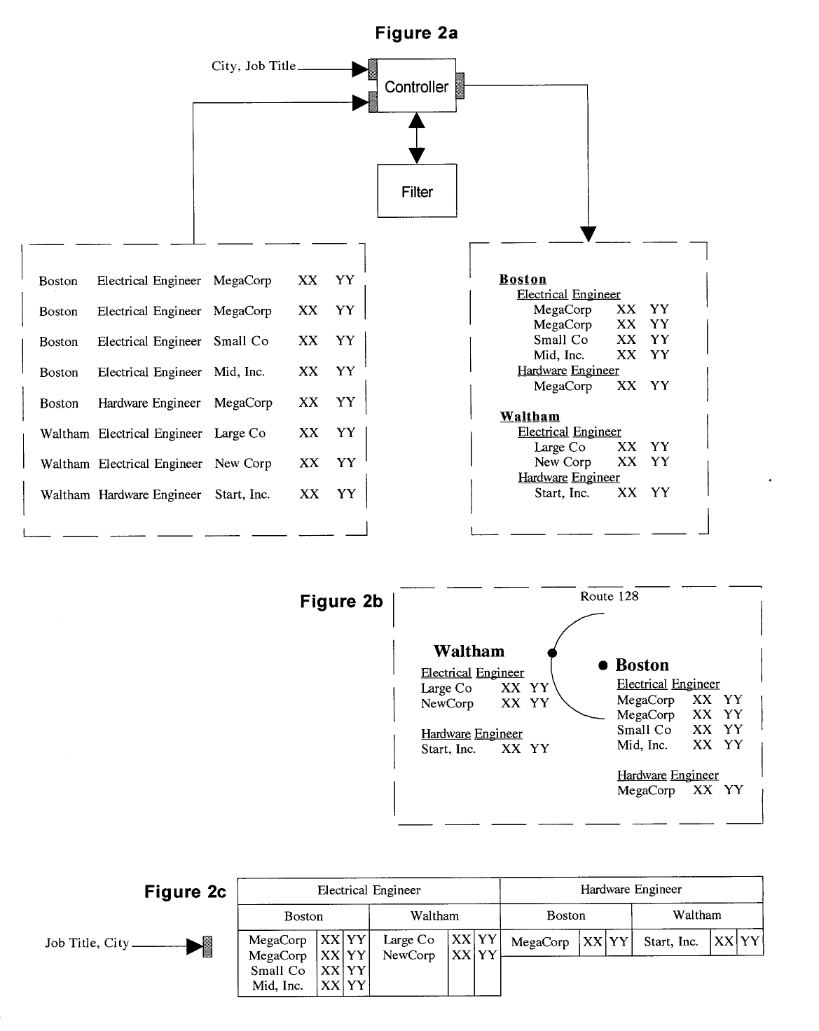

With this embodiment of the invention, users have control over the grouping criteria used to organize data. FIG. 2a illustrates one embodiment which includes two grouping data elements. If a user is reviewing a list of job openings, she may elect to group the openings first by City in order to help her locate a nearby opening, and then by Job Title to consider similar positions at the same time. Given a set of 8 data objects as input (on the left of the figure), with data elements for City, Job Title, Company, Other1 (shown with values XX) and Other2 (shown with values YY), the controller 12 and filter 20 format the data objects according to the user-specified grouping criteria, yielding a result that is much easier to read and understand. With the first level of visual grouping (acting as an outline “parent”), it's clear at a glance that there are more jobs in Boston than Waltham. With the second level of visual grouping (acting both as an outline “child” to the city and as an outline “parent” to individual openings), it's clear at a glance that, in both cities, there are more openings for Electrical Engineers than for Hardware Engineers. At the inner level, it's easy for the job seeker to focus only on the values that are different, e.g. Company, since redundant values within the grouping fields have been omitted.

FIG. 2b illustrates a further example, with the same data objects and the same two grouping elements, but with a different predetermined format. In this example, the controller 12 and filter 20 arrange the City headings according to their geographical location on a highly simplified map showing the main highway that forms a semicircle around Boston. The Job Title, Company and other data elements are shown underneath.

FIG. 2c illustrates a further example, with the same data objects and the same two grouping elements though in the opposite order, and with a different predetermined format. In this example, the controller 12 and filter 20 format the groups as columns rather than rows, with a main column for each of the two Job Titles, Electrical Engineer and Hardware Engineer, and two sub-columns for Boston and Waltham, respectively, in each of these columns. The Company and other data elements are shown underneath.

Operation

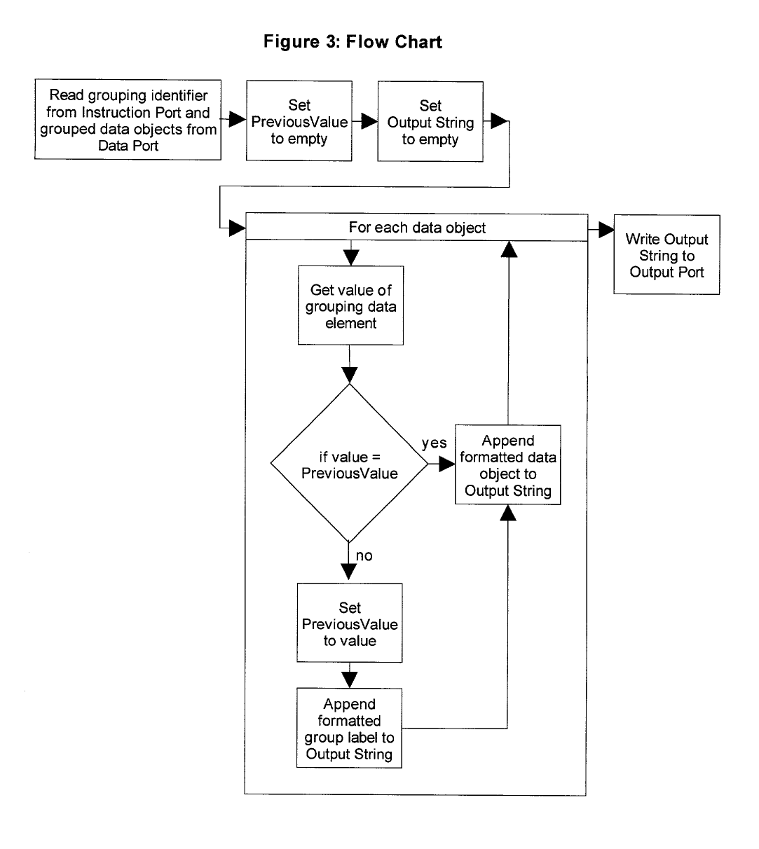

FIG. 3 is a flow chart that depicts the operation of one embodiment given input comprising a single grouping identifier and data objects that are arranged according to this grouping. Controller 12 receives the grouping identifier from instruction port 14 and the grouped data objects from data port 16, sets variables Previous Value and Output String to empty, and then iterates over each data object. For each data object, filter 20 gets the value of the grouping data element and compares the value to Previous Value. If different, it sets Previous Value to this different value (in preparation for subsequent comparisons) and appends the formatted group label to the Output String. Whether or not different, filter 20 then appends the formatted data object to the Output String. After iterating over each data object, controller 12 then sends the Output String to the output port 18.

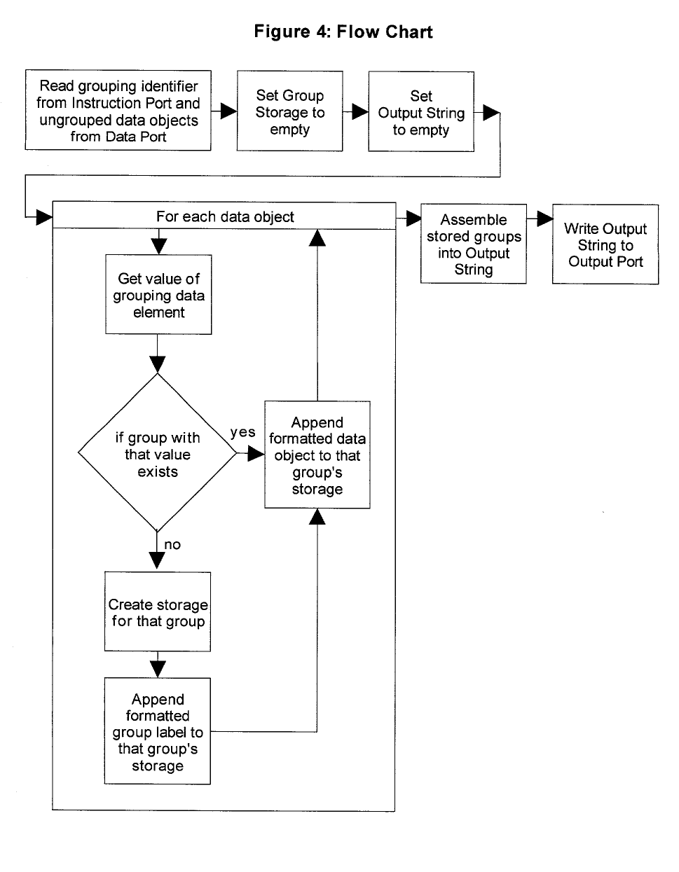

FIG. 4 is a flow chart that depicts the operation of one embodiment given input comprising a single grouping identifier and data objects that are not arranged according to this grouping. Controller 12 receives the grouping identifier from instruction port 14 and the ungrouped data objects from data port 16, sets the Group Storage area and the Output String to empty, then iterates over each data object. For each data object, filter 20 gets the value of the grouping data element and checks to see if a group with that value exists. If not, it creates storage for that group in the Group Storage area and appends the formatted group label to that group's storage area. Whether or not the group existed, filter 20 then appends the formatted data object to that group's storage area. After iterating over each data object, controller 12 then assembles the stored groups to create the Output String, and sends the Output String to the output port 18.

It will be readily apparent to those skilled in the art that variations on these two cases, such as additional grouping identifiers as input, could be handled by similar steps, with additional levels of iteration as appropriate to create nested subgroups for output. It will be further apparent that controller 12 and filter 20 could perform the same or similar functions using somewhat different steps or varying the order of certain steps, and could accept and process information from the instruction port 14 and data port in a variety of formats, each of which may differ from the other.

Alternative Embodiments

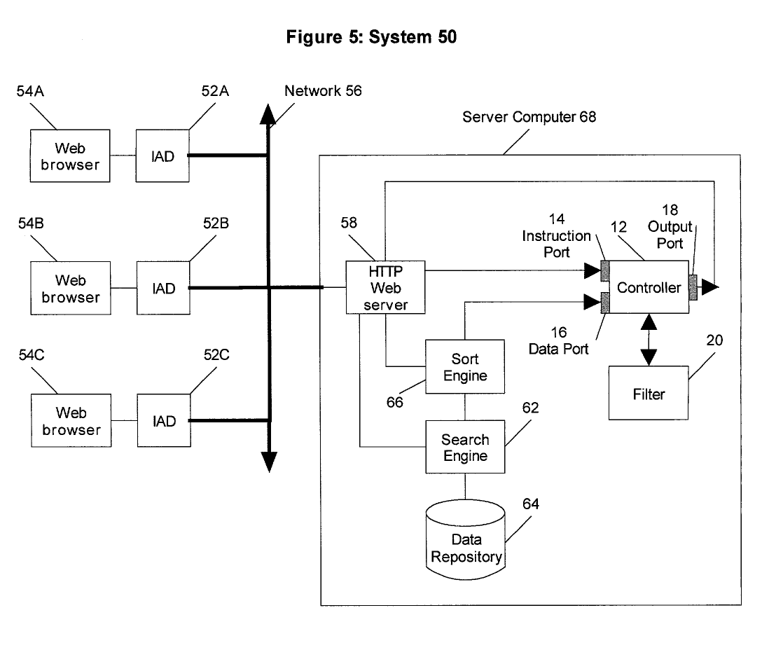

FIG. 5 depicts another illustrative embodiment of one system 50 according to the invention which receives grouping information supplied by the user over a network. The system comprises a plurality of IADs 52A-52C, each integrated with or coupled to a Web browser 54A-54C and coupled to a network 56, which is in turn coupled to an HTTP Web server 58, which is coupled to controller 12 via instruction port 14 according to the current invention. Data port 16 is configured to read data from sort engine 66, which may be coupled to HTTP Web server 58 to receive sort criteria, if any, and is coupled to search engine 62 to receive data objects. Search engine 62 may be coupled to HTTP Web server 58 to receive search criteria, if any, and is coupled to data repository 64. The controller 12 is coupled to filter 20, and is coupled via output port 18 to the HTTP Web server 58 in order to return formatted data objects to the IADs 52A-52C to display for the users on client processes such as Web browsers 54A-54C.

For this illustrative embodiment, the HTTP Web server 58, search engine 62, data repository 64, sort engine 66, the controller 12 with ports 14, 16 and 18, and the filter 20 reside on a single server computer 68.

It will be readily apparent to those skilled in the art that the functions performed in this embodiment with a single server computer 68 could be divided among a plurality of server computers from the same or different manufacturers, with each computer running the same or different operating systems.

It will be readily apparent to those skilled in the art that the HTTP Web server 58 could be WebStar, WebTen, Microsoft IIS, Apache or other commercial or open source Web server or Web development system, such as UserLand Frontier, which includes a built-in Web server. It will be readily apparent to those skilled in the art that controller 12 and filter 20 and other components could be coded in any suitable scripting or programming language such as Perl, JavaScript, Java, VBScript, Visual BASIC, C++, etc. or any suitable content management system or application server such as Vignette StoryServer, Allaire ColdFusion, SilverStream, etc. and interact with HTTP Web server 58 via CGI, plug-in, servlets, Enterprise Java Beans, etc., and that the various components need not be coded in the same language or developed in the same content management system or application server.

It will be readily apparent to those skilled in the art that search engine 62, data repository 64, and sort engine 66 could be any suitable database management system such as Oracle, Informix, Sybase, SQL Server, Access, mySQL, PostgreSQL, etc. or full-text search and sort engine and associated collection or other index mechanism such as those provided by Verity, UltraSeek, Thunderstone, etc., and/or other software capable of storing and searching data. It will be further apparent that search engine 62, data repository 64, and sort engine 66 need not be implemented using the same software nor even reside on the same computer.

Operation

The user controls one or more UDs to select sort criteria and search criteria via a Web browser 54 running on an IAD 52. The Web browser 54 sends the criteria over the network 56 via the HTTP protocol to the HTTP Web server 58 running on the server computer 68, which forwards the search criteria to search engine 62, the sort criteria to sort engine 66, and the grouping criteria to the controller 12 via instruction port 14. Controller 12 and filter 20 format the data received from the sort engine 66 via data port 16 into visually distinct groups formatted as an HTML page, and sends it to the HTTP Web server 58, which returns the HTML page over the network 56 via the HTTP protocol back to the user's Web browser 54 which displays it on the VDU of IAD 52.

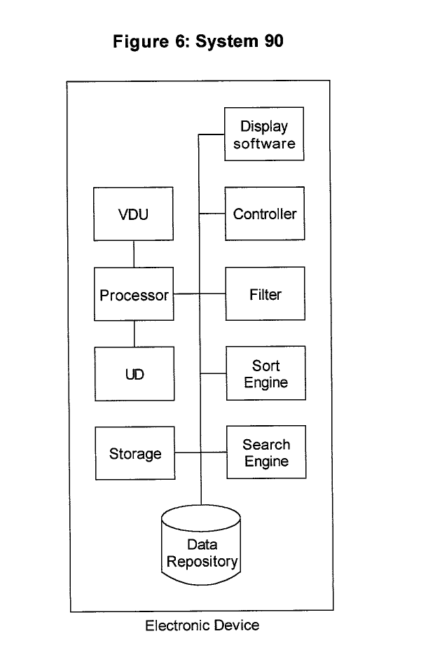

FIG. 6 depicts an illustrative embodiment of one system 90 according to the invention. The system comprises a single electronic device with at least one processor, at least one UD, at least one VDU and some form of storage, with the system 90 running software configured as one or more components to display grouping options, accept user input, perform a search on a local or embedded data repository, sort the results, format the sorted result into visually distinct groups using controller 12 and filter 20, and display the groups to the user on the VDU.

It will be readily apparent to those skilled in the art that, as depicted in FIG. 6, the controller 12 and/or filter 20 may have direct access to search engine 62 and/or to data repository 64.

It will be readily apparent to those skilled in the art that one or more of the depicted individual components could be moved to a different device, situated locally or remotely, to, for example, support a remote data repository or have certain functions performed remotely.

As previously indicated, those skilled in the art will know or be able to ascertain using no more than routine experimentation, many equivalents to the illustrative embodiments and practices described herein. It will also be understood that the methods and systems described herein provide advantages over the prior art by formatting information resulting from a search into visually distinct groups based on user input, to help users understand the scope and content of the information. Accordingly, the scope of the invention should be determined not by the embodiments disclosed herein, but by the following claims, which are to be interpreted as broadly as allowed under the law.

Furthermore, it is to be understood that the terminology used herein is for the purpose of describing particular illustrative embodiments only and is not intended to be limiting. It must be noted that as used herein, including the appended claims, the singular forms “a,” “an,” and “the” include plural referents unless the context clearly dictates otherwise.

What is claimed is:

1. An Adaptive Visual Grouping System (AVGS) for organizing a plurality of data objects for display on a Visual Display Unit (VDU) via a client process, each data object having a plurality of data elements, each data element having some or no contents, the AVGS comprising:
an instruction port configured to receive an instruction list having zero or more data element identifiers to use for grouping;
a data port configured to receive the plurality of data objects;
an output port configured to send a formatted representation of the data objects to the client process and/or to the mechanism that invoked the AVGS;
a filter configured to create a formatted representation of the data objects which, when displayed on the VDU via the client process, shows the data objects in visually distinct groups, where each group includes those data objects whose grouping data element's contents is substantially the same for every data object within the group; and
a controller configured to:
receive the instruction list from the instruction port,
receive the data objects from the data port,
invoke the filter, and
send the formatted representation to the output port;
whereby the user is presented with a visually clear and meaningful view of the data objects, organized according to the user's preferred criteria.

2. The AVGS recited in claim 1 wherein the instruction port receives at least two data element identifiers; and wherein the filter creates nested subgroups in the same fashion as other groups.

3. The AVGS recited in claim 1 wherein the instruction port receives no data element identifiers; and wherein the filter or controller selects at least one data element for grouping according to predetermined rules.

4. The AVGS recited in claim 3 wherein the first one or more data elements in the received data objects is/are selected.

5. The AVGS recited in claim 3 wherein a new group or subgroup is started for each case in which the contents of a data element in a received data object is substantially the same as the contents of the corresponding data element in another received data object, subject to a predetermined maximum number of subgroups.

6. The AVGS recited in claim 5 wherein only contiguous data objects are considered.

7. The AVGS recited in claim 1 wherein the data element identifiers are numbers that refer to the order of the data elements in the received data objects.

8. The AVGS recited in claim 1 wherein the data objects arrive ordered by the contents of the grouping data element and the filter comprises a single-pass formatting operation that determines group boundaries and creates the formatted representation.

9. The AVGS recited in claim 1 wherein the filter comprises two distinct sequential operations:
grouping
formatting

10. The AVGS recited in claim 1 wherein the controller first receives all the data objects then invokes the filter.

11. The AVGS recited in claim 1 wherein the controller first receives less than all of the data objects, invokes the filter on those received data objects, then repeats the process until all data objects have been received and filtered.

12. The AVGS recited in claim 1 wherein the groups are made visually distinct by separating with one or more lines, which line or lines may vary in thickness, style, color or otherwise to further differentiate different levels of subgroups.

13. The AVGS recited in claim 1 wherein the groups are made visually distinct by changing the text font or typeface, text size, text style, text color and/or background color of part or all of the first data object in each group of data objects.

14. The AVGS recited in claim 1 wherein the groups are made visually distinct by setting the text font or typeface, text size, text style, text color and/or background color of part or all of every data object in a given group of data objects to be a different color from the color of the similar part or all of every data object in the previous group of data objects.

15. The AVGS recited in claim 1 wherein the groups are made visually distinct by omitting the contents of the grouping data element from every data object except for one data object in each group.

16. The AVGS recited in claim 1 wherein the groups are made visually distinct by placing one copy of the contents of any grouping data element for each group in its own area as a label for its associated group.

17. The AVGS recited in claim 16 wherein the visual representation forms an outline hierarchy, with each label as an outline “parent” and the data objects in each group indented as outline “children”

18. The AVGS recited in claim 16 wherein the visual distinctness is enhanced by using one combination of text font or typeface, text size, text style, text color and background color that is common to every label and a different combination that is common to every group of data objects.

19. The AVGS recited in claim 16 wherein the visual distinctness is enhanced by omitting the contents of the grouping data element of every data object.

20. The AVGS recited in claim 16 wherein the grouping data element would, when not a grouping data element, be formatted as a hypertext link, the extracted label is not formatted as a link and the contents of the grouping data element of every data object are replaced by a text or graphical link.

21. The AVGS recited in claim 20 wherein the grouping element is a Job Title and the visual portion of the link is composed of the text “view” or similar word or phrase in English or other language.

22. The AVGS recited in claim 1 wherein the data objects are presented as a series of horizontal rows, with one or more rows per data object.

23. The AVGS recited in claim 1 wherein the data objects are presented as a series of vertical columns, with one or more columns per data object.

24. The AVGS recited in claim 1 wherein the formatted representation is expressed in plain text and/or in a portable document format.

25. The AVGS recited in claim 1 wherein the formatted representation employs a markup language including HTML, XML or SGML.

26. The AVGS recited in claim 1 wherein the formatted representation employs script and/or program code.

27. The AVGS recited in claim 1 wherein the instruction port, data port, and/or output port is/are coupled to an HTTP Web server, or coupled to a computer-readable media, or configured to communicate via a standard electronic messaging protocol.

28. The AVGS recited in claim 1 wherein the data port is coupled to a document, a database, a database management system, a search engine supporting full-text search, a search engine supporting fielded search, a search engine supporting regular expressions and/or other patterns, and/or an iterative search engine.

29. The AVGS recited in claim 1 wherein each data object is comprised of a database record, a document, or some other grouping of associated data elements.

30. The AVGS recited in claim 1 wherein each data element is comprised of a database field, tagged data including HTML, XML, or SGML, meta data, and/or a document.

31. The AVGS recited in claim 1 wherein each data element is part of a data object, the data object having at least one data unit of employment information.

32. The AVGS recited in claim 1 wherein each group includes those data objects whose grouping data element's contents are identical.

33. The AVGS recited in claim 1 wherein each group includes those data objects whose grouping data element's contents match approximately based on techniques known in the art.

34. The AVGS recited in claim 1, further including a format selection port, and wherein the filter is configured to create a specific type of formatted representation based on the selected format.

35. The AVGS recited in claim 1, further including:
a data identifier port configured to receive a list of data object identifiers;
a data cache configured to store a copy of zero or more data objects;
a cache manager configured to:
check if the indicated data object is already stored in the data cache;
if not, get a copy of the data object via the data port and store it in the data cache;
return a copy of the data object from the data cache to the controller;
and wherein the controller is configured to receive the data objects from the cache manager and/or from the data port.

36. A search system comprising:
a search port configured to receive search criteria;
an Information Location Mechanism (ILM) configured to locate zero or more data objects that match the received search criteria;
a client process and VDU to display the formatted data objects;
an AVGS as recited in claim 1 wherein the data port is coupled to the ILM and the output port is coupled to the client process which displays on the VDU.

37. The search system recited in claim 36 wherein the formatted representation from the AVGS employs a markup language including HTML, XML or SGML.

38. The search system recited in claim 36 wherein the contents of at least one data element of at least one data object include employment information.

39. The search system recited in claim 36, further including:
a sort port configured to receive sort criteria;
an Information Sorting Mechanism (ISM) coupled between the ILM and the data port of the AVGS; the ISM being configured to receive the sort criteria in a predetermined syntax, receive a plurality of data objects from the ILM, sort the data objects according to the sort criteria, and forward the sorted data objects to the AVGS via the data port.

40. An adaptive visual grouping method for organizing a plurality of data objects for display on a Visual Display Unit (VDU) via a client process, each data object having a plurality of data elements, each data element having some or no contents, the method comprising:
receiving an instruction list having zero or more data element identifiers to use for grouping;
receiving the plurality of data objects;
creating a formatted representation of the data objects which, when displayed on the VDU via the client process, shows the data objects in visually distinct groups, where each group includes those data objects whose grouping data element's contents is substantially the same for every data object within the group;
sending the formatted representation to the client process and/or to the mechanism that invoked the method;
whereby the user is presented with a visually clear and meaningful view of the data objects, organized according to the user's preferred criteria.
